(19) United States
(12) Patent Application Publication
(10) Pub. No.: US 2026/0062089 A1
(43) Pub. Date: Mar. 5, 2026

(54) ENGINE

(71) Applicant: SUZUKI MOTOR CORPORATION, Hamamatsu-shi (JP)

(72) Inventors: Shinichi YAMADA, Hamamatsu-shi (JP); Yoshikatsu AKITA, Hamamatsu-shi (JP); Shogo KOUSAKA, Hamamatsu-shi (JP)

(73) Assignee: SUZUKI MOTOR CORPORATION, Hamamatsu-shi (JP)

(21) Appl. No.: 19/281,217

(22) Filed: Jul. 25, 2025

(30) Foreign Application Priority Data
Aug. 29, 2024 (JP) 2024-147144

(51) Int. Cl. B62K 11/04; B62J 23/00; B62J 41/00; F01N 11/00; F01N 13/08

(52) U.S. Cl. CPC B62K 11/04; B62J 23/00; B62J 41/00; F01N 11/00; F01N 13/08

(57) ABSTRACT

An engine in a straddle-type vehicle is mounted on a vehicle body frame in which a down frame extends downward from a head pipe. The engine is provided with a cylinder located rearward of the down frame, a cylinder head provided on an upper surface of the cylinder, an exhaust pipe extending from the cylinder head toward a vehicle rear side, and an exhaust gas sensor configured to detect a predetermined characteristic in exhaust gas. The exhaust pipe extends downward through one lateral side of the down frame, crosses front of the down frame, and then extends upward through the other lateral side of the down frame. The exhaust gas sensor is provided on a back surface side of the exhaust pipe on the one lateral side of the down frame, and is located on an outer side with respect to the cylinder in a vehicle width direction.

### CROSS-REFERENCE TO RELATED APPLICATION(S)

This application is based on and claims priority under 35 USC 119 from Japanese Patent Application No. 2024-147144 filed on Aug. 29, 2024, the entire content of which is incorporated herein by reference.

### TECHNICAL FIELD

The present invention relates to an engine.

### BACKGROUND ART

As an engine for a straddle-type vehicle, an engine is known in which an exhaust pipe is curved in a U shape in front of a down frame (for example, see Patent Literature 1). In the engine described in Patent Literature 1, a cylinder is provided on a crankcase, and a cylinder head is provided on the cylinder. An exhaust port is formed in the front surface of the cylinder head, and the exhaust pipe extends downward from the exhaust port toward the crankcase. In front of the crankcase, the exhaust pipe is curved upward in a U shape and extends to the cylinder. The exhaust pipe passes through the lateral side of the cylinder, extends to the rear side of the vehicle, and is connected to a muffler.

### CITATION LIST

### PATENT LITERATURE

Patent Literature 1: JP3489242B

Although an exhaust gas sensor is attached to the exhaust pipe, if the exhaust pipe is curved in a U shape as the exhaust pipe in Patent Literature 1, it is difficult to assemble the exhaust gas sensor in front of the engine and to route the lead wire of the exhaust gas sensor. If the position of the exhaust gas sensor is determined in consideration of ease of assembly, the exhaust gas sensor may be damaged by foreign matter such as flying stones.

### SUMMARY

The present invention has been made in consideration of the above points, and an object of the present invention is to provide an engine that can improve the ease of assembly and protective performance of an exhaust gas sensor in a model in which the exhaust pipe crosses the front of the cylinder.

An engine according to an aspect of the present invention for solving the problems described above is an engine for a straddle-type vehicle mounted on a vehicle body frame in which a down frame extends downward from a head pipe, the engine including: a cylinder located behind the down frame; a cylinder head provided on an upper surface of the cylinder; an exhaust pipe extending from the cylinder head toward a vehicle rear side; and an exhaust gas sensor configured to detect a predetermined characteristic in exhaust gas, in which the exhaust pipe extends downward through one lateral side of the down frame, crosses front of the down frame, and then extends upward through the other lateral side of the down frame, and in which the exhaust gas sensor is provided on a back surface side of the exhaust pipe on the one lateral side of the down frame and is located on an outer side with respect to the cylinder in a vehicle width direction in a front view.

According to the engine in the aspect of the present invention, by providing the exhaust gas sensor using the space on the lateral side of the cylinder, the ease of assembly of the exhaust gas sensor is improved, and the lead wire of the exhaust gas sensor is easily routed. Since the exhaust gas sensor is provided on the back surface side of the exhaust pipe and the exhaust pipe extends from the one lateral side to the other lateral side of the down frame below the exhaust gas sensor, the exhaust pipe can protect the exhaust gas sensor from foreign matter such as flying stones.

### BRIEF DESCRIPTION OF DRAWINGS

FIG. 1 is a left side view of a straddle-type vehicle according to the present embodiment.

FIG. 2 is a left side view of the periphery of an engine according to the present embodiment.

FIG. 3 is a front view of the periphery of the engine according to the present embodiment.

FIG. 4 is a front view of the periphery of a first oxygen sensor according to the present embodiment.

FIG. 5 is a bottom view of the periphery of the engine according to the present embodiment.

FIG. 6 is a left side view of the periphery of the first oxygen sensor according to the present embodiment.

### DESCRIPTION OF EMBODIMENTS

An engine according to an aspect of the present invention is mounted on a vehicle body frame of a straddle-type vehicle. A down frame extends downward from a head pipe of the vehicle body frame, and a cylinder of the engine is positioned behind the down frame. A cylinder head is provided on an upper surface of the cylinder, and an exhaust pipe extends from the cylinder head toward a vehicle rear side. The exhaust pipe extends downward through one lateral side of the down frame, crosses front of the down frame, and then extends upward through the other lateral side of the down frame. An exhaust gas sensor is provided in the exhaust pipe to detect a predetermined characteristic in exhaust gas. The exhaust gas sensor is provided on a back surface side of the exhaust pipe on the one lateral side of the down frame, and is located on an outer side with respect to the cylinder in a vehicle width direction in the front view. By providing the exhaust gas sensor using the space on the lateral side of the cylinder, the ease of assembly of the exhaust gas sensor is improved, and the lead wire of the exhaust gas sensor is easily routed. Since the exhaust gas sensor is provided on the back surface side of the exhaust pipe and the exhaust pipe extends from the one lateral side to the other lateral side of the down frame below the exhaust gas sensor, the exhaust pipe can protect the exhaust gas sensor from foreign matter such as flying stones.

### Embodiment

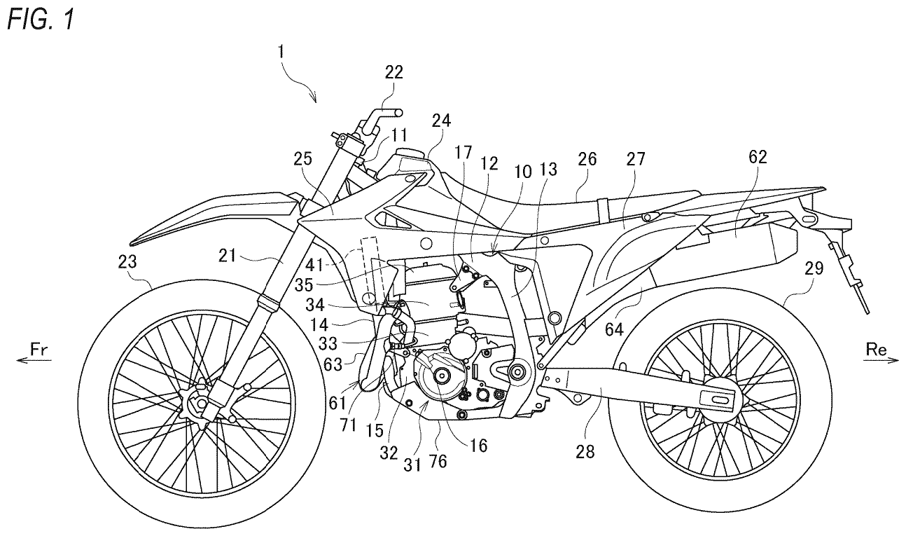

Hereinafter, a straddle-type vehicle according to the present embodiment will be described with reference to the accompanying drawings. FIG. 1 is a left side view of the straddle-type vehicle according to the present embodiment. In the following drawings, an arrow Fr indicates the vehicle front side, an arrow Re indicates the vehicle rear side, an arrow L indicates the vehicle left side, and an arrow R indicates the vehicle right side.

As shown in FIG. 1, a straddle-type vehicle 1 is implemented by mounting various components such as an engine 31 and an electrical system on a vehicle body frame 10. A pair of main frames 12 extend obliquely rearward and downward from a head pipe 11 of the vehicle body frame 10, and the rear portions of the pair of main frames 12 form a pair of body frames 13 bent downward. A down frame 14 extends downward from the head pipe 11, and an under loop 15 bent rearward is connected to the lower portion of the down frame 14. The rear end portions of the pair of under loops 15 are connected to the lower portions of the pair of body frames 13, so that the vehicle body frame 10 is formed into a cradle shape.

A front fork 21 is steerably supported on the head pipe 11 via a steering shaft (not shown). A handle 22 is provided at the upper portion of the front fork 21, and a front wheel 23 is rotatably supported on the lower portion of the front fork 21. A fuel tank 24 is placed over the upper portions of the pair of main frames 12, and the main frames 12 and the fuel tank 24 are covered by front side covers 25 from the lateral sides. A seat 26 is provided rearward of the fuel tank 24, and a seat frame (not shown) supporting the seat 26 from below is covered from the lateral sides by rear side covers 27.

A swing arm 28 is swingably supported on the body frame 13. The swing arm 28 extends rearward from the body frame 13, and a rear wheel 29 is rotatably supported at the rear end of the swing arm 28. The engine 31 is a four-stroke single-cylinder engine, and is suspended inside the vehicle body frame 10 via a plurality of suspension brackets 16 and 17. A cylinder assembly in which a cylinder 33, a cylinder head 34, and a cylinder head cover 35 are stacked is attached to the upper surface of a crankcase 32 of the engine 31. An air cleaner (not shown) is provided rearward of the cylinder head 34.

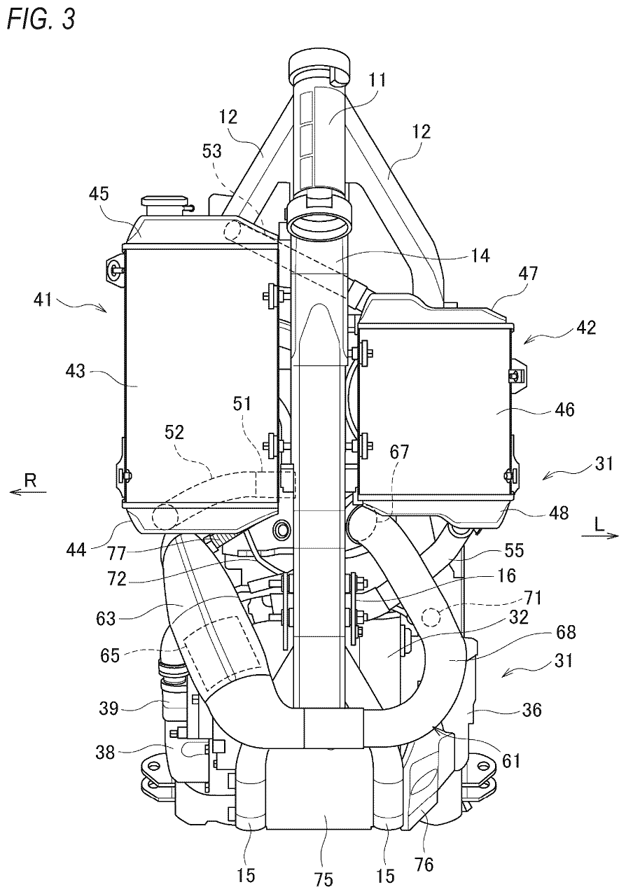

A right radiator 41 and a left radiator 42 (only the right radiator 41 is shown in FIG. 1) are located in front of the cylinder head 34, and the right radiator 41 and the left radiator 42 are attached to the down frame 14. An exhaust pipe 61 extends downward from the left side of the front surface of the cylinder head 34, and the exhaust pipe 61 passes through the right lateral side of the cylinder 33 and is connected to a muffler 62 on the vehicle rear side. A primary catalyst case 63 is formed in the exhaust pipe 61 in front of the engine 31, and a secondary catalyst case 64 is formed in the exhaust pipe 61 behind the engine 31. The primary catalyst case 63 accommodates a primary catalyst 65 (see FIG. 3), and the secondary catalyst case 64 accommodates a secondary catalyst (not shown).

Although it is necessary to provide an oxygen sensor in the exhaust pipe 61 upstream of the primary catalyst 65, it is necessary to consider the ease of assembly and protective performance of the oxygen sensor. When the oxygen sensor is provided on the back surface portion of the exhaust pipe 61 in front of the engine 31, the protective performance of the oxygen sensor is ensured. However, there is no sufficient space between the engine 31 and the exhaust pipe 61, and the ease of assembly of the oxygen sensor deteriorates. When the oxygen sensor is provided on the upper surface side or the like of the exhaust pipe 61 in front of the engine 31, the ease of assembly of the oxygen sensor is improved, but a dedicated guard member is required to ensure the protective performance. Therefore, in the present embodiment, the oxygen sensor is provided on the back surface side of the exhaust pipe 61 using the empty space on the lateral side of the cylinder 33.

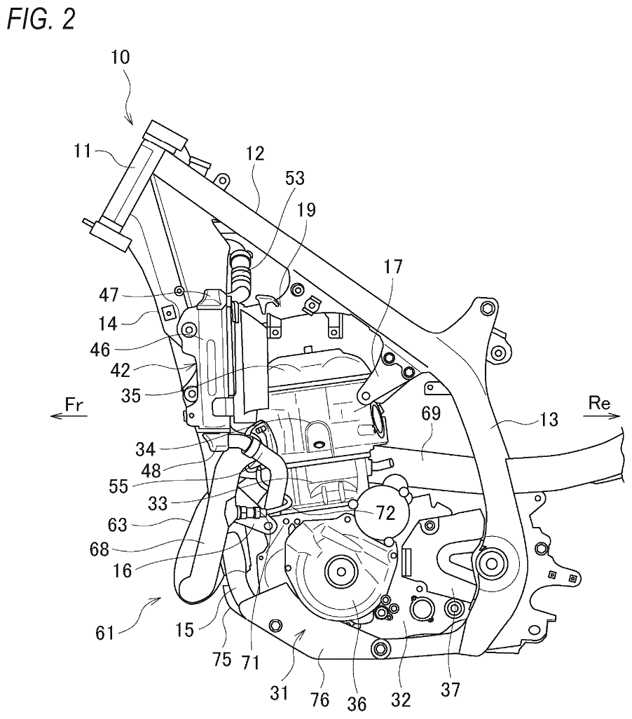

The peripheral structures of the engine will be described with reference to FIGS. 2 and 3. FIG. 2 is a left side view of the periphery of the engine according to the present embodiment. FIG. 3 is a front view of the periphery of the engine according to the present embodiment.

As shown in FIG. 2, the pair of main frames 12 and the down frame 14 are connected to each other via bridge tubes 19 for reinforcement at the upper portion of the vehicle body frame 10. Below the bridge tubes 19, the engine 31 is suspended from the vehicle body frame 10 by the suspension brackets 16 and 17. A magneto cover 36 is provided on the left side surface of the crankcase 32 of the engine 31, and a sprocket cover 37 is provided behind the magneto cover 36. A clutch cover 38 (see FIG. 3) is provided on the right side surface of the crankcase 32, and a water pump 39 (see FIG. 3) is provided in front of the clutch cover 38.

The cylinder 33 is provided on the upper surface of the crankcase 32, the cylinder head 34 is provided on the upper surface of the cylinder 33, and the cylinder head cover 35 is provided on the upper surface of the cylinder head 34. The crankcase 32, the cylinder 33, the cylinder head 34, and the cylinder head cover 35 are positioned behind the down frame 14, and the front portion of the crankcase 32 is supported on the suspension bracket 16 attached to the down frame 14. A first engine guard 75 and a second engine guard 76 are provided inside and on the left side of the under loop 15 below the engine 31. The engine 31 is protected from foreign matter such as flying stones by the first engine guard 75 and the second engine guard 76.

As shown in FIGS. 2 and 3, the right radiator 41 and the left radiator 42 are provided in front of the cylinder head 34 on both sides of the down frame 14 at the center of the vehicle. The right radiator 41 is formed larger than the left radiator 42. In the right radiator 41, a right inlet tank 44 is provided on the lower side of a right radiator core 43, and a right outlet tank 45 is provided on the upper side of the right radiator core 43. In the left radiator 42, a left inlet tank 47 is provided on the upper side of a left radiator core 46, and a left outlet tank 48 is provided on the lower side of the left radiator core 46.

A thermostat cover 51 is provided on the front surface of the engine 31, and thermostat (not shown) is provided inside the thermostat cover 51. The right inlet tank 44 is connected to the thermostat cover 51 via an inlet hose 52. The right outlet tank 45 and the left inlet tank 47 are connected to each other via an inter-radiator hose 53. The left outlet tank 48 is connected to the water pump 39 via an outlet hose (a radiator hose) 55. The upper portion of the thermostat cover 51 is connected to the right outlet tank 45 via an air vent hose (not shown).

In the right radiator 41, the cooling water flows upward from the right inlet tank 44 toward the right outlet tank 45, and while the cooling water passes through the right radiator core 43, the heat of the cooling water is radiated into the air. The cooling water is sent from the right outlet tank 45 to the left inlet tank 47 through the inter-radiator hose 53. In the left radiator 42, the cooling water flows downward from the left inlet tank 47 toward the left outlet tank 48, and while the cooling water passes through the left radiator core 46, the heat of the cooling water is radiated into the air. The heat of the cooling water is radiated in two stages by the right radiator 41 and the left radiator 42, so that the cooling efficiency is improved.

The cylinder head 34 and the intermediate portion of the outlet hose 55 are connected via a bypass hose (not shown). A bypass passage is formed by the bypass hose to bypass the right radiator 41 and the left radiator 42 and return the cooling water from the cylinder head 34 (upstream of the thermostat) to the water pump 39. When the temperature of the cooling water is lower than a predetermined temperature, the thermostat closes and the cooling water is returned from the cylinder head 34 through the bypass hose to the water pump 39. When the temperature of the cooling water is equal to or higher than the predetermined temperature, the thermostat opens, and the cooling water flows into the right radiator 41 and the left radiator 42 to cool the engine 31.

An exhaust port 67 obliquely facing the left and lower side is formed in the front surface of the cylinder head 34, and the exhaust pipe 61 is connected to the exhaust port 67. The exhaust pipe 61 extends downward from the exhaust port 67 through the left lateral side of the down frame 14, crosses the front of the down frame 14, and then extends upward through the right lateral side of the down frame 14. The exhaust pipe 61 is curved into a U shape using a space in front of the vehicle body, so that the radius of curvature of the curved portion of the exhaust pipe 61 becomes large, and the exhaust resistance is reduced. The exhaust pipe 61 extends rearward through the right lateral side of the cylinder 33, and the rear end portion of the exhaust pipe 61 is connected to the muffler 62 (see FIG. 1) near the seat 26.

The exhaust pipe 61 in front of the engine 31 is formed in a U shape by connecting an upstream pipe 68 and the primary catalyst case 63. The upstream pipe 68 obliquely extends to the left and lower side from the exhaust port 67, then is greatly curved toward the right side, and crosses the front of the down frame 14. The upstream end (the lower end) of the primary catalyst case 63 is located forward of the down frame 14, and the primary catalyst case 63 obliquely extends to the right and upper side from the downstream end of the upstream pipe 68. The primary catalyst 65 is accommodated inside the primary catalyst case 63, and air pollutants in the exhaust gas are purified as the exhaust gas passes through the primary catalyst 65. A downstream pipe 69 (see FIG. 2) extends rearward from the downstream end of the primary catalyst case 63.

In the front view, a first oxygen sensor 71 is provided on the back surface side of the upstream pipe 68, and a second oxygen sensor 77 is provided on the left surface side of the primary catalyst case 63. The first oxygen sensor 71 detects the oxygen concentration in the exhaust gas before passing through the primary catalyst 65, and the second oxygen sensor 77 detects the oxygen concentration in the exhaust gas after passing through the primary catalyst 65. The detection result of the first oxygen sensor 71 is used for feedback control of a fuel injection amount, and the detection result of the second oxygen sensor 77 is used for diagnosing catalyst deterioration. Lead wires 72 (only one of which is shown) extend upward from the rear end portions of the first oxygen sensor 71 and the second oxygen sensor 77.

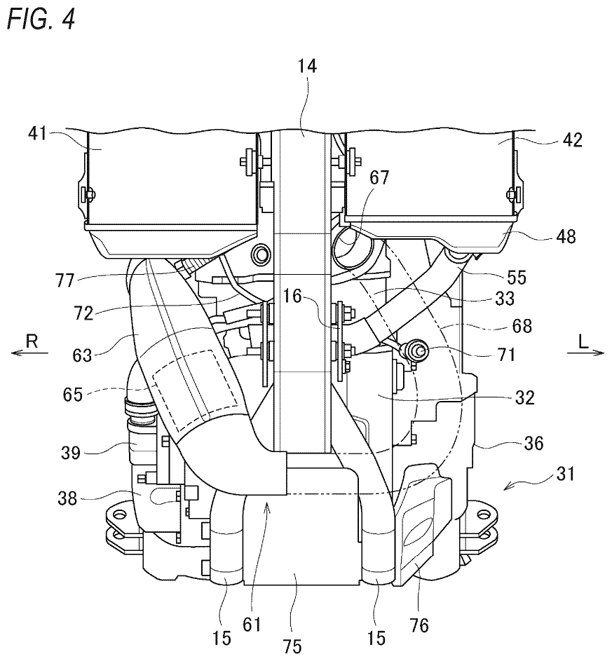

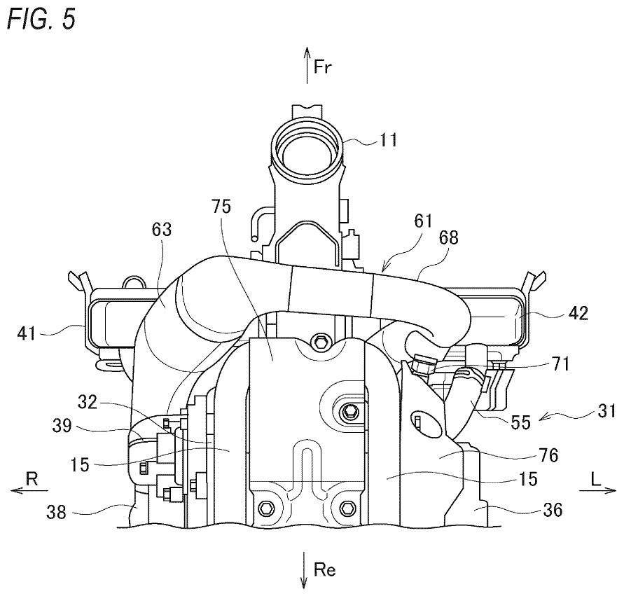

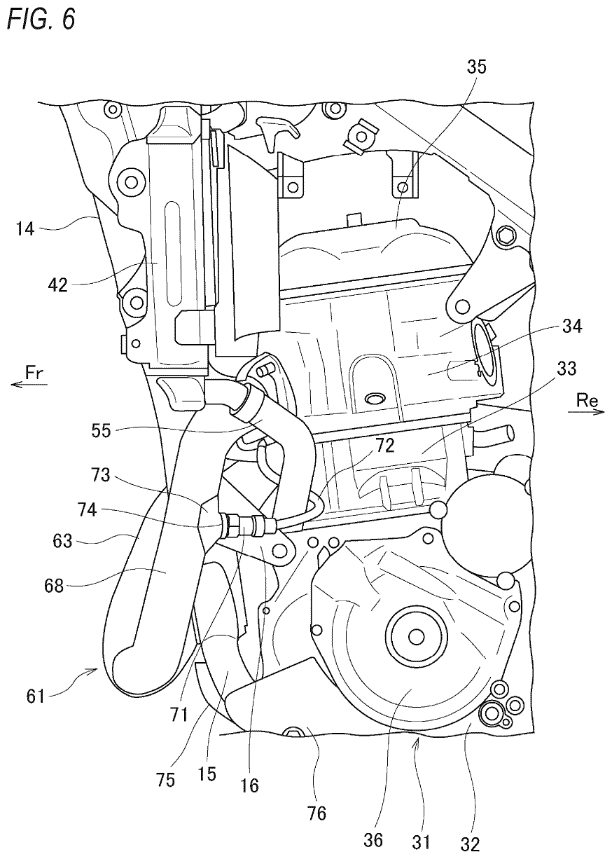

The layout of the first oxygen sensor will be described in detail with reference to FIGS. 4 to 6. FIG. 4 is a front view of the periphery of the first oxygen sensor according to the present embodiment. FIG. 5 is a bottom view of the periphery of the engine according to the present embodiment. FIG. 6 is a left side view of the periphery of the first oxygen sensor according to the present embodiment. In FIG. 4, the upstream pipe is indicated by a broken line for convenience of description.

As shown in FIG. 4, the upstream pipe 68 obliquely extends to the left and lower side from the exhaust port 67 of the cylinder head 34, and the first oxygen sensor 71 is provided on the back surface side of the upper portion of the upstream pipe 68 on the left lateral side (the one lateral side) of the down frame 14. Since the entire first oxygen sensor 71 overlaps the upstream pipe 68 in the front view and the first oxygen sensor 71 is covered with the upstream pipe 68 from the front side, the first oxygen sensor 71 is protected from foreign matter such as flying stones from the front. Since the upstream pipe 68 extends in the vehicle width direction below the first oxygen sensor 71, foreign matter scattered from below is less likely to hit the first oxygen sensor 71.

In the front view, the first oxygen sensor 71 is located on the outer side (on the left side) with respect to the cylinder 33 in the vehicle width direction, and the first oxygen sensor 71 overlaps the magneto cover 36. An empty space is present on the lateral side of the cylinder 33 and in front of the magneto cover 36, and the first oxygen sensor 71 is provided using this empty space. A sufficient work space is ensured on the lateral side of the engine 31, so that the ease of assembly of the first oxygen sensor 71 is improved, and the lead wire 72 of the first oxygen sensor 71 is easily routed. The lead wire 72 extends upward through the back surface side of the outlet hose 55 of the left radiator 42.

A portion of the upstream pipe 68 downstream of the first oxygen sensor 71 is curved so as to extend to the outer side with respect to the first oxygen sensor 71 in the vehicle width direction on the left side of the down frame 14 and then fold back to the right side of the down frame 14. The outer surface of the magneto cover 36 is located on the left side with respect to the leftmost position (the outermost position on the one lateral side) of the upstream pipe 68, and the outer surface of the left radiator 42 is located on the left side with respect to the outer surface of the magnet cover 36. At the time of a rollover to the left lateral side, the left radiator 42, the magneto cover 36, and the upstream pipe 68 hit the ground prior to the first oxygen sensor 71, so that damage to the first oxygen sensor 71 is prevented.

The first oxygen sensor 71 is provided in the upstream pipe 68 on the left side of the down frame 14, and the primary catalyst 65 is provided in the primary catalyst case 63 on the right side of the down frame 14. The first oxygen sensor 71 overlaps the down frame 14 in the left side view (see FIG. 6), and the primary catalyst 65 overlaps the down frame 14 in the right side view. Since the space between the primary catalyst 65 and the first oxygen sensor 71 is partitioned by the down frame 14, the hot air from the primary catalyst 65 toward the first oxygen sensor 71 is blocked by the down frame 14. The primary catalyst 65 is provided on the opposite side of the first oxygen sensor 71 with the down frame 14 interposed therebetween, so that the degree of freedom in providing the first oxygen sensor 71 is improved.

As shown in FIGS. 4 and 5, after the outlet hose 55 extends rearward from the left radiator 42, the outlet hose 55 extends toward the right lateral side of the down frame 14. In the front view, the first oxygen sensor 71 is located below the outlet hose 55, and the first oxygen sensor 71 is covered with the outlet hose 55 from above, so that the first oxygen sensor 71 is protected from foreign matter from above. Since the left radiator 42 and the outlet hose 55 are located above the first oxygen sensor 71, the ease of assembly of the first oxygen sensor 71 does not deteriorate by the left radiator 42 and the outlet hose 55.

In the bottom view, the first oxygen sensor 71 is provided in a space surrounded by the upstream pipe 68, the outlet hose 55, and the under loop 15. In this case, in the bottom view, the upstream pipe 68 is located in front of the first oxygen sensor 71, the outlet hose 55 is located on the left lateral side and the rear side of the first oxygen sensor 71, and the under loop 15 is located on the right lateral side of the first oxygen sensor 71. Since the outlet hose 55 is located on the left side with respect to the first oxygen sensor 71, the outlet hose 55 hits the ground prior to the first oxygen sensor 71 at the time of a rollover to the left lateral side, so that damage to the first oxygen sensor 71 is prevented.

As described above, the plate-shaped first engine guard 75 is attached to the inside of the under loop 15, and the plate-shaped second engine guard 76 is attached to the left side of the under loop 15. The first engine guard 75 extends in the front-rear direction so as to cover the crankcase 32 from below, and the second engine guard 76 extends in the front-rear direction so as to cover the magneto cover 36 from below. In the bottom view, the rear end portion of the first oxygen sensor 71 overlaps the second engine guard 76, and the first oxygen sensor 71 is covered with the second engine guard 76 from below, so that the first oxygen sensor 71 is protected from foreign matter from below the engine 31.

As shown in FIG. 6, a pedestal 73 bulging rearward is provided on the back surface side of the upstream pipe 68, and the first oxygen sensor 71 is provided on a boss 74 provided on the pedestal 73. The cross-sectional area of the upstream pipe 68 is increased by the bulge of the pedestal 73, and the influence of the pressure loss due to the protrusion of the distal end portion of the first oxygen sensor 71 is minimized. Even if the upstream pipe 68 has a large number of bends, the detection accuracy of the first oxygen sensor 71 is ensured. Since the boss 74 is not provided directly on the upstream pipe 68, it is not necessary to process the boss shape along the pipe shape in order to reduce the pressure loss. The boss 74 is provided on the pedestal 73, so that the boss shape is a simple cylindrical shape, and the cost is reduced.

As described above, the substantially triangular suspension bracket 16 is provided on the down frame 14, and the first oxygen sensor 71 overlaps the suspension bracket 16 in the side view. Since a space is ensured on the lateral side of the suspension bracket 16 in consideration of the ease of assembly of the engine 31, the first oxygen sensor 71 is easily provided on the upstream pipe 68 on the left lateral side of the suspension bracket 16. Since most of the first oxygen sensor 71 is covered with the suspension bracket 16 from the right lateral side, the first oxygen sensor 71 is protected from foreign matter from the right lateral side of the down frame 14, and the hot air from the primary catalyst 65 toward the first oxygen sensor 71 is blocked by the suspension bracket 16.

As described above, according to the engine 31 in the present embodiment, the first oxygen sensor 71 is provided using the space on the lateral side of the cylinder 33, so that the ease of assembly of the first oxygen sensor 71 is improved, and the lead wire 72 of the first oxygen sensor 71 is easily routed. Since the first oxygen sensor 71 is provided on the back surface side of the exhaust pipe 61 and the exhaust pipe 61 extends from the one lateral side to the other lateral side of the down frame 14 below the first oxygen sensor 71, the exhaust pipe 61 can protect the first oxygen sensor 71 from foreign matter such as flying stones.

In the present embodiment, an oxygen sensor is used as an example of an exhaust gas sensor. Alternatively, the exhaust gas sensor may be any sensor capable of detecting the average characteristics of the exhaust gas, and may be, for example, an exhaust temperature sensor that detects the exhaust temperature of the exhaust gas.

In the present embodiment, the first and second oxygen sensors serving as the exhaust gas sensors are provided in the exhaust pipe, but it is sufficient that at least one exhaust gas sensor is provided in the exhaust pipe.

In the present embodiment, the vehicle body frame is provided with an under loop, but the shape of the vehicle body frame is not particularly limited as long as an under frame extends downward from at least the head pipe in the vehicle body frame.

In the present embodiment, a water-cooled engine is exemplified as the engine. Alternatively, the engine may be an air-cooled engine or an oil-cooled engine.

The engine according to the present embodiment is not limited to being used in the off-road type straddle-type vehicle described above, and may be used in other types of straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, a first aspect provides an engine (31) for a straddle-type vehicle (1) mounted on a vehicle body frame (10) in which a down frame (14) extends downward from a head pipe (11), the engine (31) including: a cylinder (33) located behind the down frame; a cylinder head (34) provided on an upper surface of the cylinder; an exhaust pipe (61) extending from the cylinder head toward a vehicle rear side; and an exhaust gas sensor (a first oxygen sensor 71) configured to detect a predetermined characteristic in exhaust gas, in which the exhaust pipe extends downward through one lateral side of the down frame, crosses front of the down frame, and then extends upward through the other lateral side of the down frame, and in which the exhaust gas sensor is provided on a back surface side of the exhaust pipe on the one lateral side of the down frame and is located on an outer side with respect to the cylinder in a vehicle width direction in a front view. According to this configuration, by providing the exhaust gas sensor using the space on the lateral side of the cylinder, the ease of assembly of the exhaust gas sensor is improved, and the lead wire of the exhaust gas sensor is easily routed. Since the exhaust gas sensor is provided on the back surface side of the exhaust pipe and the exhaust pipe extends from the one lateral side to the other lateral side of the down frame below the exhaust gas sensor, the exhaust pipe can protect the exhaust gas sensor from foreign matter such as flying stones.

A second aspect is directed to the first aspect, in which a portion of the exhaust pipe downstream of the exhaust gas sensor is curved so as to extend to an outer side with respect to the exhaust gas sensor in the vehicle width direction on the one lateral side of the down frame and then fold back to the other lateral side of the down frame. According to this configuration, damage to the exhaust gas sensor can be prevented by the exhaust pipe hitting the ground prior to the exhaust gas sensor at the time of a rollover to the one lateral side. The exhaust gas sensor can be protected from foreign matter by the shape of the exhaust pipe.

A third aspect is directed to the first and second aspects, in which the engine further includes a pair of radiators (a left radiator 42 and a right radiator 41) provided on both lateral sides of the down frame, and a radiator hose (an outlet hose 55) extending from the radiator (the left radiator 42) on the one lateral side of the down frame, and in which the exhaust gas sensor is located below the radiator hose in the front view. According to this configuration, the ease of assembly of the exhaust gas sensor does not deteriorate by the radiator and the radiator hose. The exhaust gas sensor is covered with the radiator hose from above, so that the exhaust gas sensor can be protected from foreign matter from above.

A fourth aspect is directed to the third aspect, in which the radiator hose extends rearward from the radiator on the one lateral side of the down frame and then extends to the other lateral side of the down frame, and in which the exhaust gas sensor is provided in a space surrounded by the exhaust pipe and the radiator hose in a bottom view. According to this configuration, damage to the exhaust gas sensor can be prevented by the radiator hose hitting the ground prior to the exhaust gas sensor at the time of a rollover to the one lateral side.

A fifth aspect is directed to any one of the first to fourth aspects, in which a suspension bracket (16) for the engine is attached to the down frame, and the exhaust gas sensor overlaps the suspension bracket in a side view. According to this configuration, since a space is ensured on the lateral side of the suspension bracket in consideration of the ease of assembly of the engine, the exhaust gas sensor is easily provided on the exhaust pipe on the one lateral side of the suspension bracket. The exhaust gas sensor is covered with the suspension bracket from the other lateral side, so that the exhaust gas sensor can be protected from foreign matter from the other lateral side of the down frame.

A sixth aspect is directed to any one of the first to fifth aspects, in which the engine further includes an engine guard (a second engine guard 76) for engine protection provided below the engine, and in which the exhaust gas sensor overlaps the engine guard in a bottom view. According to this configuration, the exhaust gas sensor is covered with the engine guard from below, so that the exhaust gas sensor can be protected from foreign matter from below the engine.

A seventh aspect is directed to any one of the first to sixth aspects, in which a pedestal (73) bulging rearward is provided on a back surface side of the exhaust pipe, and the exhaust gas sensor is provided on the pedestal. According to this configuration, the cross-sectional area of the exhaust pipe is increased by the bulge of the pedestal, and the influence of the pressure loss due to the protrusion of the exhaust gas sensor can be minimized. The detection accuracy of the exhaust gas sensor can be ensured even in the exhaust pipe having a large number of bent portions.

An eighth aspect is directed to any one of the first to seventh aspects, in which the engine further includes a catalyst (a primary catalyst 65) provided in the exhaust pipe on the other lateral side of the down frame, and in which the exhaust gas sensor and the catalyst overlap the down frame in a side view. According to this configuration, the hot air from the catalyst toward the exhaust gas sensor can be blocked by the down frame. The catalyst is provided on the opposite side of the exhaust gas sensor with the down frame interposed therebetween, so that the degree of freedom in providing the exhaust gas sensor can be improved.

Although the present embodiment has been described, a part or all of the embodiment and modification described above may be combined as another embodiment.

The technique according to the present invention is not limited to the embodiment described above, and may be variously changed, replaced, or modified without departing from the gist of the technical concept. Further, the present invention may be implemented by other methods as long as the technical concept can be implemented by the methods through advance of the technique or other derivative techniques. Therefore, the claims cover all embodiments that may fall within the scope of the technical concept.

1. An engine for a straddle-type vehicle mounted on a vehicle body frame in which a
down frame extends downward from a head pipe, the engine comprising:
a cylinder located behind the down frame;
a cylinder head provided on an upper surface of the cylinder;
an exhaust pipe extending from the cylinder head toward a vehicle rear side; and
an exhaust gas sensor configured to detect a predetermined characteristic in exhaust gas,
wherein the exhaust pipe extends downward through one lateral side of the down frame, crosses front of the down frame, and then extends upward through the other lateral side of the down frame, and
wherein the exhaust gas sensor is provided on a back surface side of the exhaust pipe on the one lateral side of the down frame and is located on an outer side with respect to the cylinder in a vehicle width direction in a front view.

2. The engine according to claim 1, wherein a portion of the exhaust pipe downstream of the exhaust gas sensor is curved so as to extend to an outer side with respect to the exhaust gas sensor in the vehicle width direction on the one lateral side of the down frame and then fold back to the other lateral side of the down frame.

3. The engine according to claim 1, further comprising:
a pair of radiators provided on both lateral sides of the down frame; and
a radiator hose extending from the radiator on the one lateral side of the down frame,
wherein the exhaust gas sensor is located below the radiator hose in the front view.

4. The engine according to claim 3,
wherein the radiator hose extends rearward from the radiator on the one lateral side of the down frame and then extends to the other lateral side of the down frame, and
wherein the exhaust gas sensor is provided in a space surrounded by the exhaust pipe and the radiator hose in a bottom view.

5. The engine according to claim 1,
wherein a suspension bracket for the engine is attached to the down frame, and the exhaust gas sensor overlaps the suspension bracket in a side view.

6. The engine according to claim 1, further comprising
an engine guard configured to protect the engine is provided below the engine,
wherein the exhaust gas sensor overlaps the engine guard in a bottom view.

7. The engine according to claim 1,
wherein a pedestal bulging rearward is provided on a back surface side of the exhaust pipe, and the exhaust gas sensor is provided on the pedestal.

8. The engine according to claim 1, further comprising
a catalyst provided in the exhaust pipe on the other lateral side of the down frame,
wherein the exhaust gas sensor and the catalyst overlap the down frame in a side view.
